(19) United States
(12) Patent Application Publication
(10) Pub. No.: US 2021/0259471 A1
(43) Pub. Date: Aug. 26, 2021

(54) A BLADE HUB ASSEMBLY

(71) Applicant: BREVILLE PTY LIMITED, Alexandria (AU)

(72) Inventors: Eddie SIU, Alexandria (AU); Khon THAI, Alexandria (AU)

(21) Appl. No.: 17/256,007

(22) PCT Filed: Jun. 24, 2019
(86) PCT No.: PCT/AU2019/050649

§ 371 Date: Dec. 24, 2020

(30) Foreign Application Priority Data
Jun. 25, 2018 (AU) 2018902276

(51) Int. Cl. A47J 43/07; A47J 43/046; B02C 18/18

(52) U.S. Cl. CPC A47J 43/0761; B02C 18/18; A47J 43/046; A47J 43/0722

(57) ABSTRACT

A blade hub assembly (10) for a kitchen device (120) having a receiving aperture (80) with a profile (90), the assembly (10) having a rotational axis (11) about which the assembly (10) is driven, the assembly (10) comprising: a hub body (20), the hub body (20) having: a first profile (30); and a second profile (40), the hub body (20) being insertable in the receiving aperture (80) in an insertion direction (50), and wherein the first and second profile (30, 40) are arranged such that, when the first profile (30) is aligned with the aperture profile (90), the second profile (40) interferes with the aperture profile (90).

### FIELD

This invention relates to a blade hub assembly for a kitchen device.

### BACKGROUND

Presently available kitchen devices often use a construction having a vessel assembly comprising a bowl and a blade hub assembly inserted therein. This construction allows the blade hub assembly to be removed from the vessel, which is advantageous for cleaning of the vessel and the blade hub assembly, for example in a dishwasher.

Due to the forces exerted on the blades, the blade hub assembly is often constructed from robust engineering materials, such as stainless steel, which cause the blade hub assembly to have significant weight. The design of presently available vessel assemblies often requires a locking part that retains the blade hub assembly in its position in the bowl. A common problem is that unlocking of the locking part leads to the blade hub assembly falling from its position in the bowl. As users frequently perform the unlocking operation with an open end of the bowl facing downwards, the falling blade hub assembly can damage a surface on which the bowl rests, or severely injure a user's foot.

### SUMMARY OF INVENTION

It is an object of the present invention to at least substantially address one or more of the above disadvantages, or at least provide a useful alternative to the above described devices.

In a first aspect the present invention provides a blade hub assembly for a kitchen device having a receiving aperture with a profile, the assembly having a rotational axis about which the assembly is driven, the assembly comprising:
a hub body, the hub body having:
   a first profile; and
   a second profile,
the hub body being insertable in the receiving aperture in an insertion direction, and
   wherein the first and second profile are arranged such that, when the first profile is aligned with the aperture profile, the second profile interferes with the aperture profile.

Preferably, the second profile is angularly offset from the first profile about the insertion direction such that, when the first profile is aligned with the aperture profile, the second profile interferes with the aperture profile.

Preferably, the aperture profile includes at least one recess, and wherein the first profile and/or the second profile includes at least one protrusion to be received in the recess.

Preferably, the number of recesses and the number of protrusions in one of the first and second profile is the same.

Preferably, the protrusion is tapered in the insertion direction with respect to the recess.

Preferably, the first profile includes at least one protrusion, and the protrusion is adapted to resist a torque applied by the recess.

Preferably, the aperture profile includes six recesses and the first profile includes six protrusions.

Preferably, the second profile has fewer protrusions than the first profile.

Preferably, the number of protrusions in the second profile is a multiplicative factor of the number of protrusions in the first profile.

Preferably, the first profile and the second profile include protrusions to be received in the recess, and wherein the protrusions of the first profile are spaced from the protrusions of the second profile by a distance of between 10 mm to 35 mm.

Preferably, the second profile includes at least one protrusion, the protrusion of the second profile being adapted to support the blade hub assembly.

In a second aspect the present invention provides a blade hub assembly for a kitchen device having a receiving aperture, the assembly having a rotational axis about which the assembly is driven, the assembly comprising:
a hub body that is insertable in the receiving aperture in an insertion direction, the hub body having a number of first protrusions and a number of second protrusions, the second protrusions being angularly offset about the axis, and axially spaced along the axis, from the first protrusions.

Preferably, the first protrusions are angularly equally distributed about the axis; and
the second protrusions are angularly equally distributed about the axis.

Preferably, an angular distance between the second protrusions is twice an angular distance between the first protrusions.

In a third aspect the present invention provides a vessel assembly for a kitchen device, the assembly comprising
a bowl having a receiving aperture;
the blade hub assembly according to the first aspect, with the hub being inserted in the receiving aperture in an insertion direction; and
a locking member adapted to secure the blade hub assembly to the bowl.

Preferably, the locking member is movable between a secure position and a first free position, and wherein the locking member has a locking profile adapted to engage the second profile of the blade hub assembly such that:

in the secure position, the locking profile engages the second profile and secures the blade hub assembly to the vessel; and
in the first free position, the blade hub assembly is angularly movable about the insertion direction with respect to the vessel.

Preferably, the locking member is in the first free position, the blade hub assembly is angularly movable about the insertion direction to a second free position, wherein, in the second free position, the blade hub assembly is removable from the receiving aperture.

Preferably, when the locking member is moved from the secure position to the first free position, the blade hub assembly is supported by the aperture profile contacting the second profile.

In a fourth aspect the present invention provides a kitchen device having the vessel according to the third aspect.

### BRIEF DESCRIPTION OF DRAWINGS

Preferred embodiments of the present invention will now be described, by way of examples only, with reference to the accompanying drawings:

FIG. 1 is an isometric view of a blade hub assembly according to the invention.

FIG. 2 is a top plan view of a bowl to be used with the blade hub assembly of FIG. 1.

FIG. 3 is a detail section view of the blade hub assembly of FIG. 1 inserted in the bowl of FIG. 2.

FIG. 4 is a detail section view of the blade hub assembly of FIG. 1 inserted in the bowl of FIG. 2 and secured thereto by a locking member.

FIG. 5 is a detail isometric view of the blade hub assembly of FIG. 1 inserted in the bowl of FIG. 2.

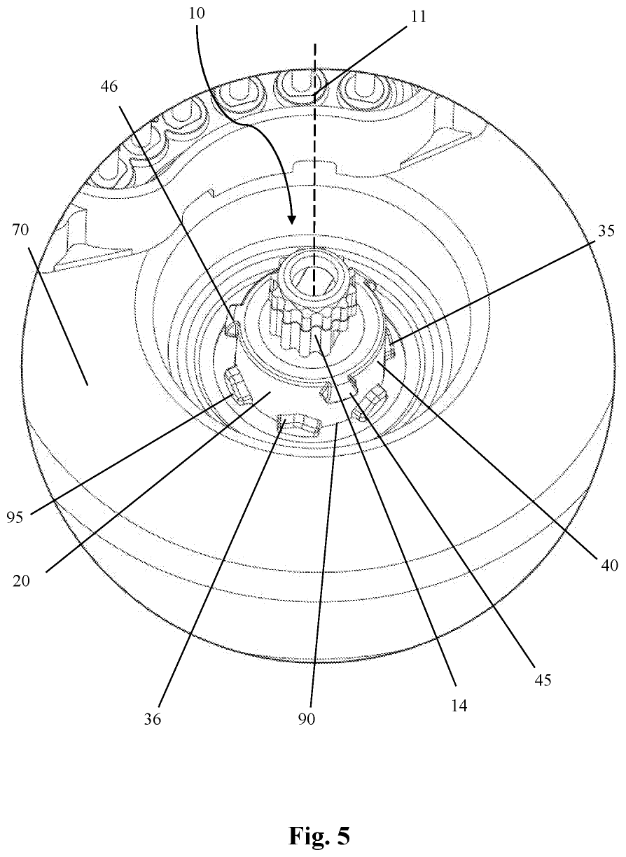

FIG. 6 is an isometric section view of a vessel assembly including the blade hub assembly of FIG. 1 and the bowl of FIG. 2.

FIG. 7 is an isometric view of a kitchen device having the vessel assembly of FIG. 6.

### DESCRIPTION OF EMBODIMENTS

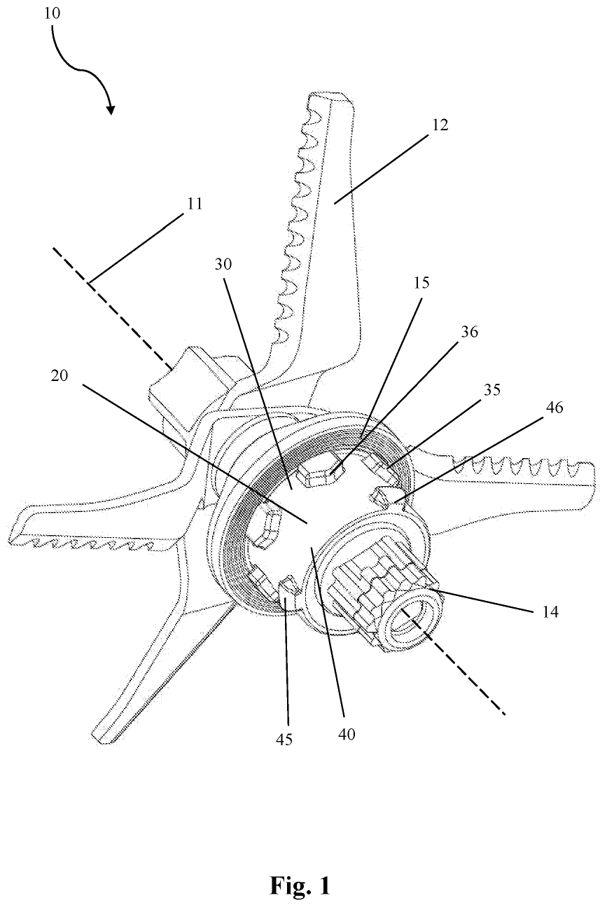

According to the present disclosure, as seen in FIG. 1, a blade hub assembly 10 includes a hub body 20, a set of blades 12, a drive gear 14, and a ledge 15. The blade hub assembly 10 further includes a first profile 30 formed by the hub body 20 and a number of first protrusions 35, in the preferred embodiment there are six first protrusions 35. The blade hub assembly 10 further includes a second profile 40 formed by the hub body 20 and a number of second protrusions 45, in the preferred embodiment there are three second protrusions 45. The assembly 10 has a central rotational axis 11 about which the blade hub assembly 10 is rotated.

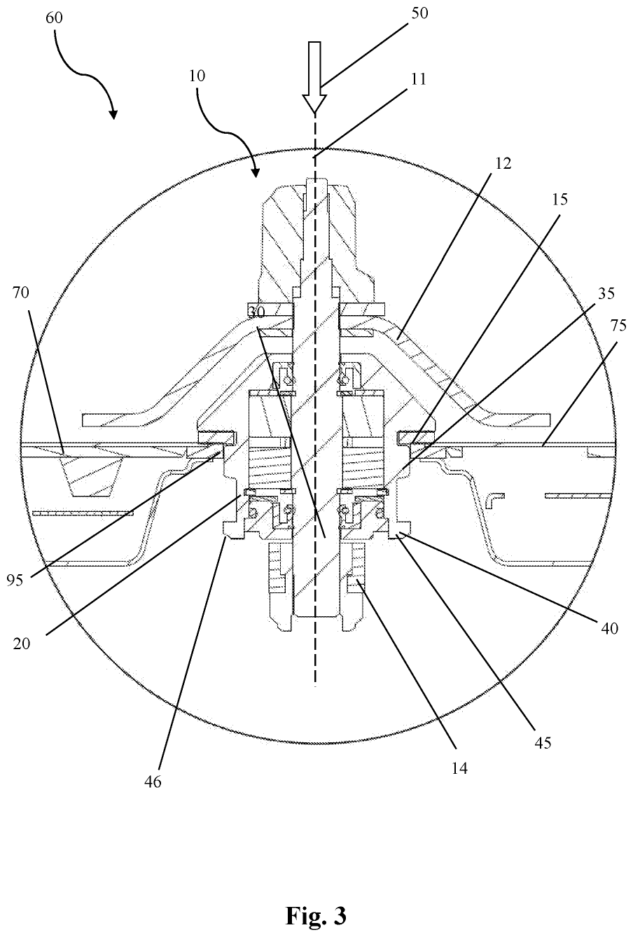

As best shown in FIG. 1, The first protrusions 35 are tapered at a lower portion 36 in an insertion direction 50, shown in FIG. 3. Similarly, the second protrusions 45 are tapered at a lower portion 46 in the insertion direction 50 shown in FIG. 3. Further, the second protrusions 45 are spaced from the first protrusions 35 by a distance of about 10 mm to 35 mm in the insertion direction 50. The second protrusions 45 are also angularly offset about the axis 11 from the first protrusions 35, such that the second protrusions 45 are located between the first protrusions 35, when viewed in the insertion direction 50, that is the protrusions 35 and 45 are not aligned in the insertion direction 50. As there are, in the preferred embodiment, fewer second protrusions 45 than first protrusions 35, the second protrusion 45 occupies every second gap between the first protrusions 35. Further, as shown in FIG. 1, the first protrusions 35 are angularly equally spaced by 60° on the hub body 20 about the axis 11. Similarly, the second protrusions 45 are angularly equally spaced by 120° on the hub body 20 about the axis 11.

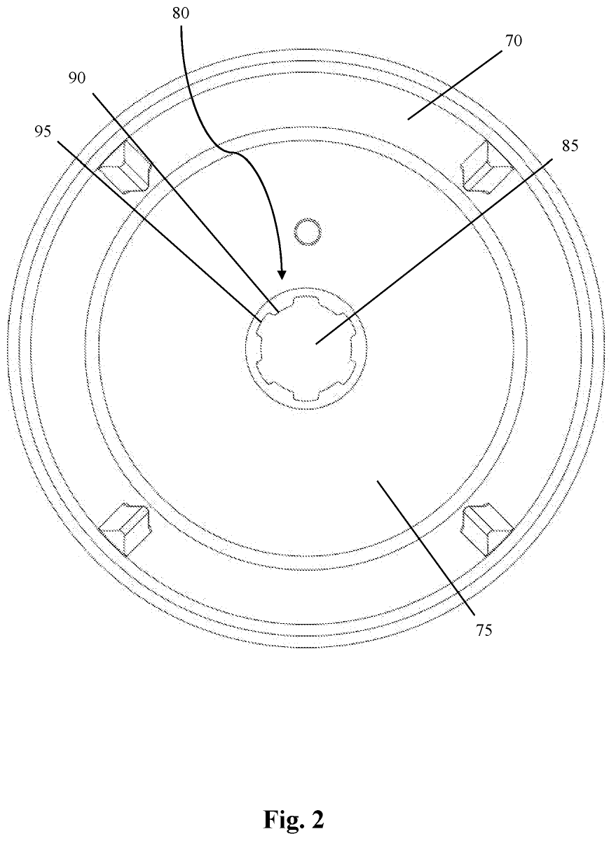

FIGS. 3, 4, and 6 are intended to describe the insertion and retention of the blade hub assembly 10 into a bowl 70, shown in FIG. 2. To best describe the interrelationship between the integers the first and second profiles 30, 40 are not shown to be angularly offset, such that only one section view of the assembly 10 is required. It will be understood that the preferred embodiment remains the angular offset of the first and second protrusions 35, 45 about the axis 11. However, as best seen in FIG. 3, the second protrusions 45 are generally smaller in size than the first protrusions 35.

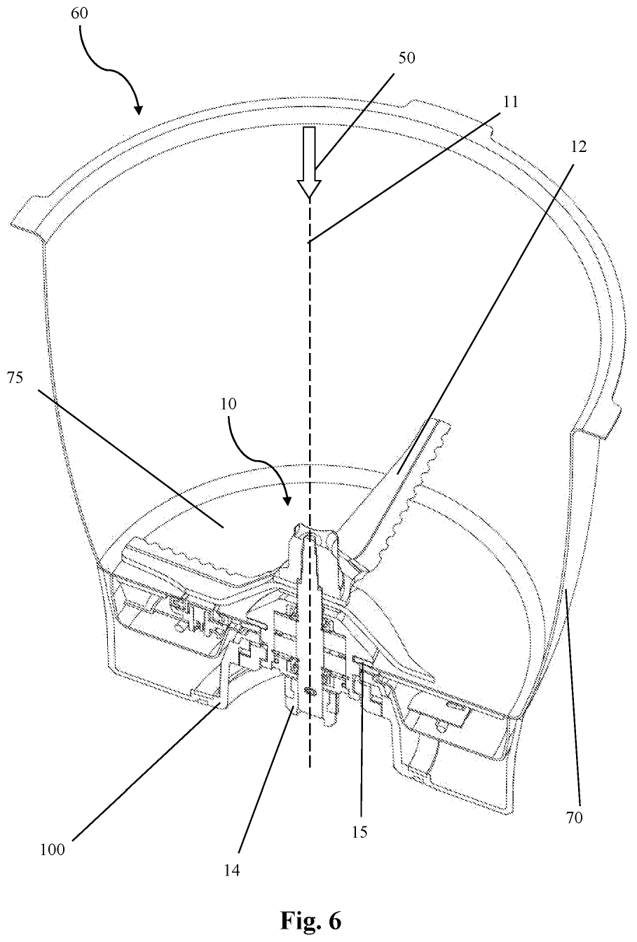

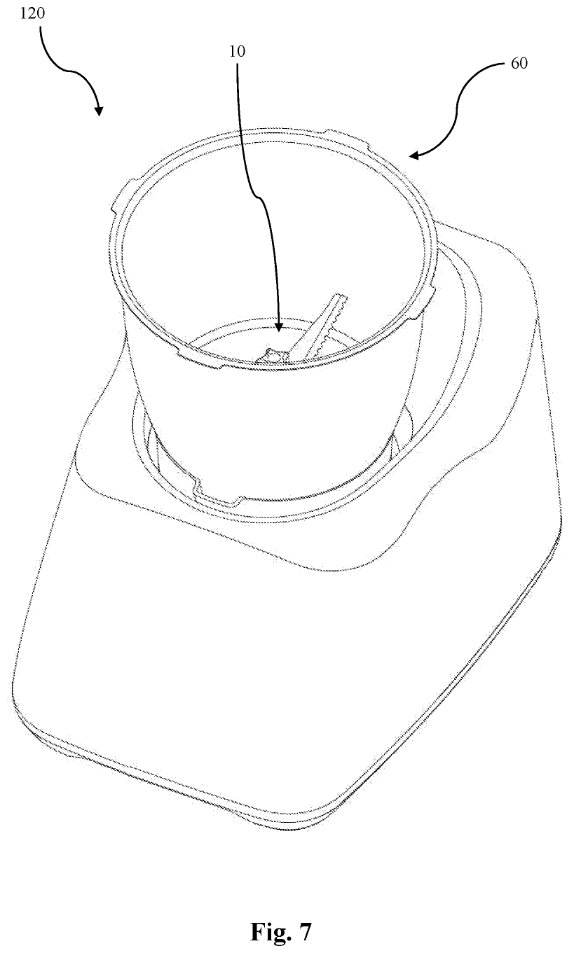

The blade hub assembly 10 is adapted to be inserted into a bowl 70, shown in FIG. 2, of a vessel assembly 60 in the insertion direction 50. The vessel assembly 60, shown in FIG. 6, is typically used in a kitchen device 120, shown in FIG. 7. As best seen in FIG. 2, the bowl 70 has a floor 75 and a receiving aperture 80 located in the floor 75. The receiving aperture 80 has an aperture profile 90 defined by an opening 85 and a number of recesses 95 extending therefrom into the material of the bowl 70. In the preferred embodiment, there are six recesses 95.

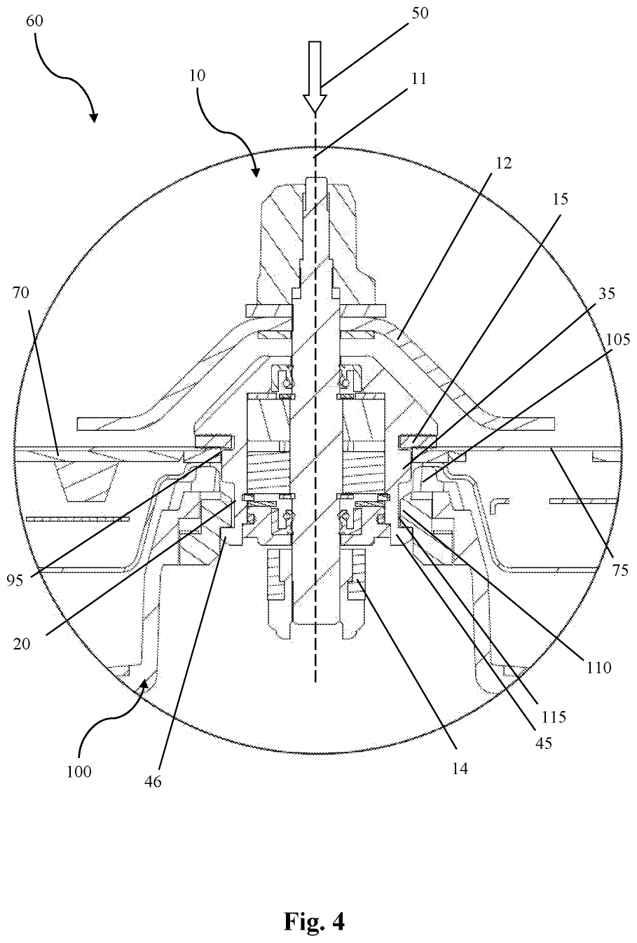

As shown in FIG. 4, the vessel assembly 60 further includes a locking member 100 having a locking profile 110 and an upper portion 105. The locking profile 110 has a number of projections 115, in the preferred embodiment the locking profile 110 has three projections 115.

Use of the blade hub assembly 10 will now be discussed.

The blade hub assembly 10 is inserted into the bowl 70 by positioning the blade hub assembly 10 at a distance opposite the insertion direction 50 away from the bowl 70. The blade hub assembly 10 is rotated about the insertion direction 50 until the second protrusions 45 of the second profile 40 are each aligned with a recess 95 of the aperture profile 90. Once aligned, the blade hub assembly 10 is advanced in the insertion direction 50 until the second protrusions 45 of the second profile 40 have advanced beyond the floor 75 of the bowl 70. This relative rotational position between the blade hub assembly 10 and the receiving aperture 80 is a second free position.

The blade hub assembly 10 is now rotated yet again about the insertion direction 50 until each of the first protrusions 35 of the first profile 30 is aligned with a recess 95 of the aperture profile 90. The blade hub assembly 10 is then advanced in the insertion direction 50 until the first protrusions 35 of the first profile 30 are engaged in the recesses 95 of the aperture profile 90 thereby preventing rotation of the blade hub assembly 10 about the insertion direction 50. Typically, the ledge 15 abuts the floor 75 in this position. The first protrusions 35 are now able to resist a torque applied by the recesses 95.

To complete the vessel assembly 60, the locking member 100 is now positioned at a distance along the insertion direction 50 away from the bowl 70. The locking member 100 is rotated until each projection 115 is not aligned with a second protrusion of the second profile 40. The locking member 100 is then advanced against the insertion direction 50 until the upper portion 105 abuts the bowl 70. This relative position between the receiving aperture 80, the blade hub assembly 10, and the locking member 100 is a first free position.

The locking member 100 is now rotated about the insertion direction 50 until each projection 115 engages a second protrusion 45 of the second profile 40, thereby securing the blade hub assembly 10 against movement along the insertion direction 50. This position is a secure position. In the secure position, the drive gear 14 may be engaged by an appropriate drive (not shown) of a kitchen device 120, shown in FIG. 7, to rotate the set of blades 12.

Advantages of the blade hub assembly 10 will now be discussed.

As the second protrusions 45 are angularly offset from the first protrusions 35, when the locking member 100 is moved from the secure position to the first free position, the blade hub assembly 10 may move under the influence of gravity against the insertion direction 50. However, as the second protrusions 45 are not aligned with the recesses 95, the blade assembly 10 comes to a rest when the second protrusions 45 abut the bowl 70. This substantially reduces the likelihood that the blade hub assembly 10 will uncontrollably fall out of the vessel assembly 60 and injure users or damage items below the vessel assembly 60.

The number of recesses 95, and correspondingly the number of first protrusions 35, is chosen based on two driving behaviours. Firstly, a larger number of recesses 95 would increase the probability that a random positioning of the blade hub assembly 10 would result in the first protrusions 35 being aligned with the recesses 95. This simplifies the insertion process for the user. Secondly, however, a larger number of recesses 95 reduces the linear extent of material between recesses 95. This increases the probability that when the locking member 100 is rotated from the secure position to the first free position and the blade hub assembly 10 drops, subject to disturbances or movement of the bowl 70, the second protrusions 45 may not engage the bowl 70, but, due to the higher probability of the second protrusions 45 aligning with the recesses 95, the blade hub assembly 10 drops from the bowl 70 altogether. Six recesses 95, as present in the preferred embodiment, satisfies both of these design criteria, enabling easy and safe insertion and disconnection of the blade hub assembly 10 with the vessel assembly 60.

It is preferred that the number of recesses 95 and first protrusions 35 are the same, to distribute the torque applied by the recesses 95 to the same number of first protrusions 35 and avoid shearing failure of the receiving aperture 90.

It is preferred that the number of second protrusions 45 is lower than the number of first protrusions 35 to save weight and cost. However, it is even more preferred that the number of second protrusions 45 is a multiplicative factor of the number of first protrusions 35, such that a plurality of possible alignment positions exist between the second profile 40 and the aperture profile 90. It is also advantageous if the number of second protrusions 45 is at least 3, so that the blade hub assembly 10 is balanced when supported on the second protrusions 45 by the bowl 70.

Because the first protrusions 35 and the second protrusions 45 are spaced by 10 mm to 35 mm, it is easy to accommodate the width of a typical human finger between the first and second protrusions 35, 45. This assists in preventing injuries that users may be exposed to when attempting to grip the blade hub assembly 10 by the set of blades 12.

Although the invention has been described with reference to specific examples, it will be appreciated by those skilled in the art that the invention may be embodied in many other forms.

For example, the second protrusions 45 could be equal in size to the first protrusions 35.

1. A blade hub assembly for a kitchen device having a receiving aperture with a profile, the assembly having a rotational axis about which the assembly is driven, the assembly comprising:
a hub body, the hub body having:
a first profile; and
a second profile,
the hub body being insertable in the receiving aperture in an insertion direction, and wherein the first and second profile are arranged such that, when the first profile is aligned with the aperture profile, the second profile interferes with the aperture profile.

2. The blade hub assembly of claim 1, wherein the second profile is angularly offset from the first profile about the insertion direction such that, when the first profile is aligned with the aperture profile, the second profile interferes with the aperture profile.

3. The blade hub assembly of claim 1 or 2, wherein the aperture profile includes at least one recess, and wherein the first profile and/or the second profile includes at least one protrusion to be received in the recess.

4. The blade hub assembly of claim 3, wherein the number of recesses and the number of protrusions in one of the first and second profile is the same.

5. The blade hub assembly of claim 3 or 4, wherein the protrusion is tapered in the insertion direction with respect to the recess.

6. The blade hub assembly of any one of claims 3 to 5, wherein the first profile includes at least one protrusion, and the protrusion is adapted to resist a torque applied by the recess.

7. The blade hub assembly of claim 6, wherein the aperture profile includes six recesses and the first profile includes six protrusions.

8. The blade hub assembly of any one of claims 3 to 7, wherein the second profile has fewer protrusions than the first profile.

9. The blade hub assembly of claim 8, wherein the number of protrusions in the second profile is a multiplicative factor of the number of protrusions in the first profile.

10. The blade hub assembly of any one of claims 3 to 9, wherein the first profile and the second profile include protrusions to be received in the recess, and wherein the protrusions of the first profile are spaced from the protrusions of the second profile by a distance of between 10 mm to 35 mm.

11. The blade hub assembly of any one of claims 3 to 10, wherein the second profile includes at least one protrusion, the protrusion of the second profile being adapted to support the blade hub assembly.

12. The blade hub assembly of any one of claims 3 to 11, wherein the protrusions of the second profile are equal or smaller than the protrusions of the first profile.

13. A blade hub assembly for a kitchen device having a receiving aperture, the assembly having a rotational axis about which the assembly is driven, the assembly comprising:
a hub body that is insertable in the receiving aperture in an insertion direction, the hub body having a number of first protrusions and a number of second protrusions, the second protrusions being angularly offset about the axis, and axially spaced along the axis, from the first protrusions.

14. The blade hub assembly of claim 13, wherein:
the first protrusions are angularly equally distributed about the axis; and
the second protrusions are angularly equally distributed about the axis.

15. The blade hub assembly of claim 14, wherein an angular distance between the second protrusions is twice an angular distance between the first protrusions.

16. A vessel assembly for a kitchen device, the assembly comprising
a bowl having a receiving aperture;
the blade hub assembly of any one of claims 1 to 15, with the hub being inserted in the receiving aperture in an insertion direction; and
a locking member adapted to secure the blade hub assembly to the bowl.

17. The vessel assembly of claim 16, wherein the locking member is movable between a secure position and a first free position, and wherein the locking member has a locking profile adapted to engage the second profile of the blade hub assembly such that:
in the secure position, the locking profile engages the second profile and secures the blade hub assembly to the vessel; and
in the first free position, the blade hub assembly is angularly movable about the insertion direction with respect to the vessel.

18. The vessel assembly of claim 17, wherein, when the locking member is in the first free position, the blade hub assembly is angularly movable about the insertion direction to a second free position, wherein, in the second free position, the blade hub assembly is removable from the receiving aperture.

19. The vessel assembly of claim 17 or 18, wherein, when the locking member is moved from the secure position to the first free position, the blade hub assembly is supported by the aperture profile contacting the second profile.

20. A kitchen device having the vessel of any one of claims 15 to 19.
